(19) United States
(12) Patent Application Publication
(10) Pub. No.: US 2007/0132241 A1
(43) Pub. Date: Jun. 14, 2007

(54) Coupling with layered sealing

(75) Inventor: Jochen Mueller, Karlsruhe (DE)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/302,666

(22) Filed: Dec. 14, 2005

(51) Int. Cl. F16L 21/00

(52) U.S. Cl. 285/399

(57) ABSTRACT

A coupling with a first fluid conduit adapted for conducting a fluid and comprising an end to be coupled, a layered structure adapted for providing a channel and adapted for coupling the channel with the end of the first conduit, and a first aperture in the layered structure. The aperture is adapted for introducing the end of the at least one conduit.

### BACKGROUND ART

1. Field of the Invention

The present invention relates to coupling conduits.

2. Discussion of the Background Art

Couplings are used for allowing conduits adapted for conducting a medium to communicate. Known are, for example, light guides or fluid conduits for conducting light or a fluid, for example a liquid. A capillary, for example, can serve as a fluid conduit and as a light guide. Flow cells, for example, for analyzing a fluid can comprise a fluid conduit and a light guide. Flow cells can comprise different conduits communicating via one or more connections.

U.S. Pat. No. 6,526,188 B2 and the US 2001/0010747 show a modular flow cell having a high optical throughput, a long optical path length and a small cross-section. The modular flow cell configuration includes remote ports or connections for liquid and light input and liquid and light output.

U.S. Pat. No. 5,444,807 shows a flow-through cell for use in the measurement of chemical properties of small volumes of fluid containing dissolved analytes.

U.S. Pat. No. 5,608,517 discloses a coated flow cell and a method for making the coated flow cell. The flow cell comprises a flow passage, wherein light directed into the flow cell is internally reflected down the flow passage.

U.S. Pat. No. 3,236,602 discloses flow cells and holders therefore, the colorimetric examination of a liquid to determine the quantity of a substance present in the liquid.

U.S. Pat. No. 4,477,186 discloses a photometric cuvette for optical analyses of through-flowing medium, made as a thin and narrow transparent tube requiring minimum sample amounts. Light, substantially parallel to the tube length, is led obliquely into the tube through its wall, is reflected and is led obliquely out through the tube wall to a detector.

EP 008915781 discloses an optical detector cell for determining the presence of a solute in a sample fluid. The optical detector cell includes a sample tube, inlet and outlet means for the sample fluid, and a first and second optical waveguide for passing a beam of light axially through the sample tube.

GB 2193313 A discloses an apparatus and method for measuring the spectral absorbance of fluid samples. The length of the light path through the sample is adjusted to optimize the amount of light absorbed by the sample.

U.S. Pat. No. 6,281,975 B1 shows a bent capillary flow cell with protruding end bulbs coaxial with centreline of an elongated centre cylindrical section of capillary tubing. The bulbs provide a high light throughput entrance window for the cell.

### SUMMARY OF THE INVENTION

It is an object of the invention to provide an improved coupling of conduits. The object is solved by the independent claims. Further embodiments are shown by the dependent claims.

According to embodiments of the present invention, a coupling comprising a first fluid conduit, a layered structure, and a first aperture is suggested. Advantageously, a fluid can be conducted through the first conduit. The first fluid conduit can comprise an end that can be coupled to another conduit. The layered structure can comprise a channel adapted for conducting a fluid. Advantageously, the channel can be coupled with the end of the first fluid conduit by the layered structure. For this purpose, the layered structure comprises a first aperture, wherein the aperture is adapted for introducing or receiving the end of the first conduit. The first conduit can be inserted into the first aperture of the layered structure for coupling the end of the first conduit with the channel of the layered structure. Besides this, the first conduit can comprise one or more ends to be coupled, wherein said layered structure is adapted for coupling said channel with one or more conduits.

Embodiments may comprise one or more of the following. The layered structure of the coupling can comprise a plurality of different layers. The different layers can comprise different functions, for example, can comprise the channel. Besides this, the layers can seal the first conduit and the channel against any leakage flow. For this purpose, the layered structure can comprise a first sealing layer. For protecting AND/OR FIXING the sealing layer, the layered structure can comprise a cover layer, for example, comprising a resistant material.

The channel leads into the aperture for coupling the channel with the end of the first conduit being inserted into the aperture. For realizing the channel, a plurality of middle layers can be combined with each other, for example, a first middle layer laminated with a second middle layer, wherein the first middle layer comprises a groove. Advantageously, a second middle layer laminated with the first middle layer and the groove of the first middle layer can confine the channel. Besides this, the channel can be realized by the first middle layer comprising a slit, wherein the first middle layer is laminated on both sides with the second middle layer and a third middle layer, wherein the slit of the first middle layer and the second and third middle layers confine the channel. Besides this, flexible layers can be combined with solid/rigid/stable parts.

In embodiments, the coupling comprises at least one middle layer comprising the channel, for example, realized as a bore and one sealing layer laminated with the first middle layer. For this purpose, the aperture can be realized as a blind hole through the sealing layer and partly through the first middle layer. For coupling the end of the conduit with the channel of the first middle layer, the channel has to end up in the aperture of the layered structure. In further embodiments, the coupling can comprise at least three layers, the first sealing layer, at least one middle layer and a second sealing layer. For this purpose, the layered structure of the coupling can comprise two apertures, wherein the second aperture is adapted for receiving a second conduit. The first sealing layer can provide a seal for the first conduit and the second sealing layer can provide a seal for the second conduit. The at least one middle layer comprises the channel adapted for conducting a fluid into at least one of the coupled conduits. For example, the channel can be adapted for channeling a fluid to an end of at least one of the conduits. The channel ends up in one of the conduits via one of the apertures.

Possibly, the coupling can be adapted for coupling a light guide and the first conduit. For this purpose, the light guide can end up in an inner tube of the first conduit, for example, in the end of the first conduit. Advantageously, the light guide can end up coaxially into the end of the first fluid conduit. Advantageously, by this, the light guide can be used for irradiating a fluid conducted within the first conduit.

For this purpose, the first and second apertures can be realized as a through hole within the layered structure adapted for introducing the ends of the first conduit and second conduit, for example, the light guide. Advantageously, by this, both conduits can be inserted into the layered structure, wherein the first conduit is inserted into the first sealing layer and the second conduit is inserted into the second sealing layer. Advantageously, the two apertures or rather the through bore of the layered structure can be realized as a stepped bore, wherein the first conduit can be inserted in the wider part of the stepped bore of the apertures. The first and second sealing layers can be laminated with the middle layers. Advantageously, any leakage flow from the first middle layer comprising the channel towards the outside of the coupling can be avoided.

Embodiments may comprise one or more of the following. The coupling can comprise a plurality of apertures, for example a plurality of pairs of apertures, wherein each pair of apertures is realized as a through hole within the layered structure of the coupling. Furthermore, at least one channel can couple at least one pair of the apertures or rather through holes. Advantageously, by this, a fluid can be channeled between at least two apertures for connecting two fluid conduits inserted into the layered structure. Additionally, each pair of apertures can receive one fluid conduit and one light guide for bringing them in communication.

Embodiments may comprise one or more of the following. Advantageously, the sealing material of the layered structure or better the sealing material of the first and second sealing layers can surround the ends of at least one conduit of said first and/or second conduits. For realizing a sealing contact between the surrounded outer surface of the conduit and the sealing material, the sealing material can be heat treated. By this, the sealing material or better the plastic material can at least BE partly plastified and/or melted. Thereafter, the plastic material can be solidified.

Advantageously, this enables a compound, for example, a chemical compound between the surface of the conduit and the plastic material. Besides this, the plastic material can shrink on the surface of the conduit by cooling it for realizing an additional bond by frictional forces. The plastic material can comprise, for example, polyetheretherketone (PEEK), one of a broad range of flouropolymeres, in particular perfluoroamines (PFA) or fluorinated ethylen-propylene copolymer (FEP), duroplastic material or compound, in particular polyimide, and/or liquid crystal polymers (LCP).

Further embodiments of the present invention relate to a fluidic system adapted for handling a fluid. The fluidic system can comprise a coupling. Advantageously, the coupling can be adapted for connecting, sealing, fixing, adjusting, aligning, receiving, protecting, and positioning a first conduit. Besides this, the fluidic system can comprise a flow cell for housing a fluid sample and for exposing the fluid sample to radiation for analyzis. Advantageously, the flow cell can comprise at least one of the couplings.

Finally, embodiments of the invention relate to a method of coupling the first conduit with the channel by the coupling. The ends of the first conduit can be inserted partly into the first aperture. The sealing material of the layered structure of the coupling can be heated at least partly. Advantageously, by this, the sealing material can be plastified and/or melted at least partly.

### BRIEF DESCRIPTION OF THE DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a longitudinal view of a coupling comprising a layered structure, a first fluid conduit and a wave guide,

FIG. 2 shows the longitudinal view of the coupling of FIG. 1 after sealing he first fluid conduit by a heat treatment,

FIG. 3 shows a top view of a middle layer of the layered structure of the coupling of FIG. 1, wherein the first middle layer comprises a groove,

FIG. 4 shows a top view of another embodiment of a first middle layer comprising a slit,

FIG. 5 shows a top view of a middle layer adapted for coupling two fluid conduits and comprising a groove, and

FIG. 6 shows a schematic view of a fluidic system comprising two flow cells connected in series.

### DETAILED DESCRIPTION OF THE PREFERRED EMBODIMENT

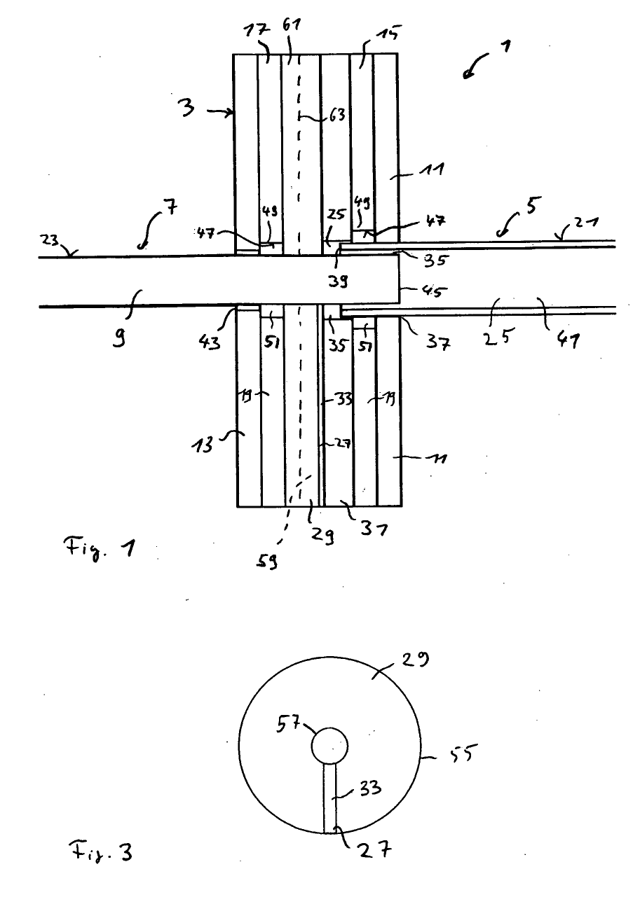

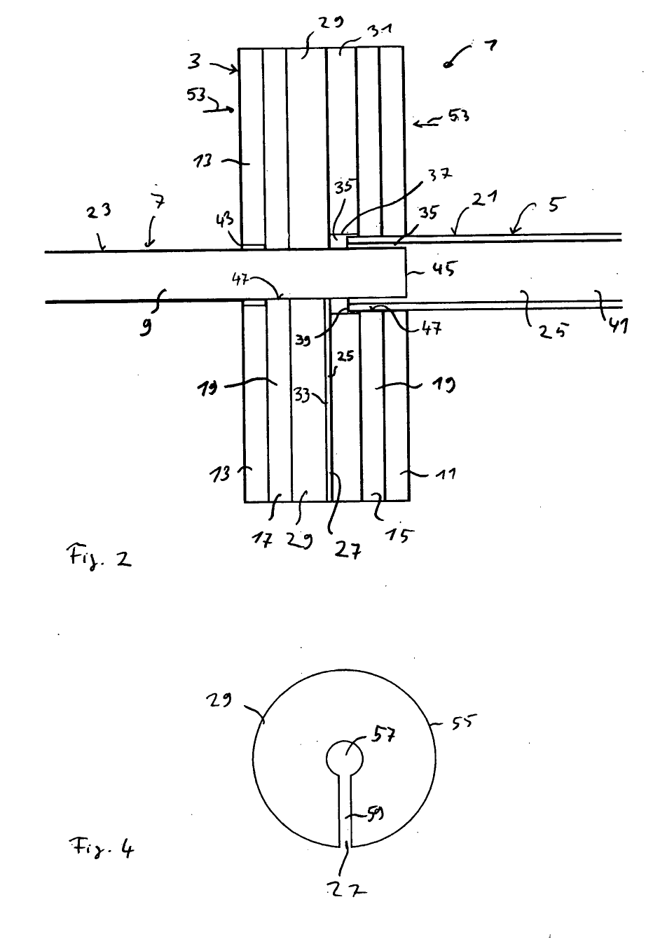

FIGS. 1 and 2 show a longitudinal view of a coupling 1 comprising a layered structure 3, a first fluid conduit 5 and a second conduit comprising a light guide 9. FIG. 2 shows the coupling 1 after a heat treatment of the coupling 1 for sealing the first fluid conduit 5.

The layered structure 3 of the coupling 1 comprises a plurality of layers laminated to each other. More precisely, the layered structure 3 comprises a first cover layer 11 and a second cover layer 13. The first and second cover layers 11 and 13 are adapted for protecting a first sealing layer 15 and a second sealing layer 17 of the coupling 1. The first and second sealing layers 15 and 17 each are laminated to one of the first and second cover layers 11 and 13. The first and second sealing layers 15 and 17 each comprise a sealing material comprising a plastic material 19. The plastic material 19 can be adapted for being at least partly plastified and/or melted and for surrounding an outer surface 21 of the first fluid conduit 5 and an outer surface 23 of the second conduit 7 or rather the light guide 9 in a sealing contact. The plastic material 19 of the second sealing layer 17 surrounds the outer surface 23 of the light guide 9 and the first sealing layer 15 surrounds the outer surface 21 of the first conduit 5 for sealing a fluid path 25 of the coupling 1 against any leakage flow.

The fluid path 25 of the coupling 1 comprises a channel 27 provided by a first middle layer 29 and a second middle layer 31. The first middle layer 29 and the second middle layer 31 are laminated to each other, wherein the first middle layer 29 comprises a groove 33. The groove 33 of the first middle layer 29 is covered by the second middle layer 31. By this, the channel 27 of the fluid path 25 of the coupling 1 can be provided and confined.

Furthermore, the fluid path 25 comprises a circular gap 35. The circular gap 35 is realized by a first aperture 37 within the layered structure 3 of the coupling 1. The channel 27 of the fluid path 25 ends up in the first aperture 37 of the coupling 1. The first aperture 37 can be realized as a bore through the first cover layer 11, the first sealing layer 15, and the second middle layer 31. The diameter of the bores of the first cover layer 11 and the second middle layer 31 are adapted to the outer diameter of the outer surface 21 of the first fluid conduit 5.

Advantageously, by this, the first fluid conduit 5 can be inserted into the bores of the first aperture 37 of the layered structure 3, for example, in a loose fit or in a press fit. An end 39 of the first fluid conduit 5 is inserted into the first aperture 37. As shown in the FIGS. 1 and 2, the end 39 of the first fluid conduit 5 is inserted completely through the first cover layer 11 and the first sealing layer 15. In the bore of second middle layer 31, the end 39 of the first fluid conduit 5 is inserted partly, wherein an inner tube 41 of the first fluid conduit 45 ends up in the circular gap of the second middle layer 31 of the coupling 1. It can be seen, that the fluid path 25 connects the inner tube 41 of the first fluid conduit 5 and the channel 27 via the circular gap 35 within the first aperture 37 in a span of the second middle layer 31. Besides this, the layered structure 3 of the coupling 1 comprises a second aperture 43 realized by bores of the laminated second cover layer 13, second sealing layer 17, and the first middle layer 29.

The light guide 9 comprises an optical outlet 45 inserted through the second aperture 43 partly into the inner tube 41 of the first fluid conduit 5. By this, a fluid conducted within the inner tube 41 of the first fluid conduit can be irradiated by the light guide 9. The outer diameter of the light guide 9 is smaller than the inner diameter of the inner tube 41 of the first fluid conduit 5. By this, a circular gap 47 remains. The circular gap is adapted for conducting a fluid and is part of the fluid path 25. Advantageously, such a coupling can be used for providing a flow cell.

As can be seen in FIG. 1, the first and second sealing layers 15 and 17 each comprise a bore 49, wherein the diameter of the bores 49 is wider than the according outer surfaces 23 and 21 of the light guide 9 and the first fluid conduit 5. By this, circular gaps 51 remain between the inner surfaces of the bores 49 and the outer surfaces 23 and 21 of the light guide 9 and the first fluid conduit 5. Advantageously the fragile parts are better assemblable.

For sealing the fluid path 25 of the coupling 1, the coupling 1 can be heat treated. Firstly, the first fluid conduit 5 and the second conduit 7 or rather the light guide 9 can be inserted in the according apertures 37 and 43. For example, firstly, the first fluid conduit 5 can be inserted into the first aperture 37, and thereafter the second conduit 7 can be inserted into the second aperture 43 and additional into the inner tube 25 of the first conduit 5. Thereafter, the fluid path 25 of the coupling 1 can be sealed by the first and second sealing layers 15 and 17. For this purpose, the plastic material 19 of the first and second sealing layers 15 and 17 can be heated, for example, at least partly nearby the outer surfaces 21 and 23 of the first and second conduits 5 and 7. This can be realized, for example, by inducing a current, and/or by leading a hot fluid through the flow path 25 or alike. In other embodiments, the complete coupling 1 can be heated for plastifying and/or melting the plastic material 19 of the first and second sealing layer 15 and 17. Possibly, the sealing contact of the plastic material 19 of the first and second sealing layers 15 and 17 with the outer surfaces 21 and 23 of the first and second fluid conduits 5 and 7 can be realized by exerting pressure to the layered structure 3 of the coupling 1. The layered structure 3 can be pressed, for example, by a not shown tool in direction of two arrows 53. By pressing and/or heating the plastic material 19, the circular gaps 47—as shown in FIG. 1—can be closed for providing the sealing contact—as shown in FIG. 2—of the first and second sealing layers with the outer surfaces 21 and 23 of the first and second conduits 5 and 7. Advantageously, the plastic material can also be an elastomeric material.

The inner bore 49 comprises an inner surface 47 confining the circular gap 51—before heating, FIG. 1—or rather being in a sealing contact with one of the conduits 5 or 7—after heating.

After heating the sealing material or better the plastic material 19 for plastifying and/or melting, the plastic material can be solidified. By this, the first and second conduits 5 and 7 can be sealed and fixed within the first and second apertures 37 and 43. Possibly, the plastic material 19 can be heated and solidified within a tool. For this purpose, possibly, the first and second cover layers 11 and 13 are not necessary. Consequently, the coupling 1 can be provided without the first and second cover layers 11 and 13. In other embodiments, the coupling 1 can comprise an additional not shown housing, for example, instead of the first and second cover layers 11 and 13 and for confining the plastic material 19 within the housing.

FIG. 3 shows the first middle layer 29 of the layered structure 3 of the coupling 1. The first middle layer 29 can be realized, for example, as a flat washer 55 comprising the groove 33 and an inner bore 57. The inner bore 57 is a part of the second aperture 43.

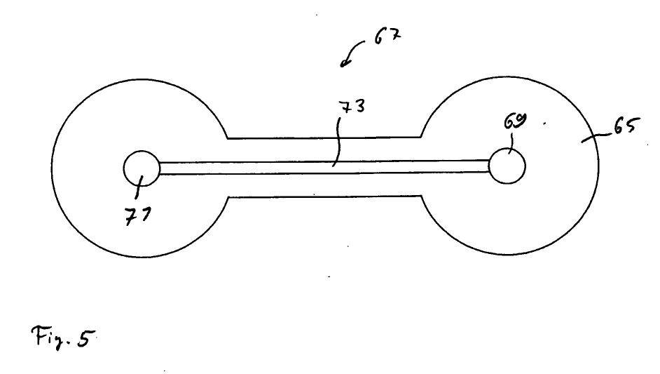

FIG. 4 shows another embodiment of the first middle layer 29 comprising a slit 59. For realizing the channel 27, the first middle layer 29 comprising the slit 59 can be laminated with the second middle layer 31 and a further third middle layer 61. The layers can be laminated for providing a fluid tight joint by gluing, pressing, bonding, chemically compounding and/or alike. The third middle layer 61 is indicated in FIG. 1 by a dashed line 63. Each side of the washer 55 of the first middle layer 29 comprising the slit 59 is laminated with one of the second and third middle layers 31 and 61. By this, the channel 27 can be confined by the slit 59 and the second and third middle layers 31 and 61. Consequently, for realizing the channel 27, the layered structure 3 of the coupling 1 comprises three middle layers. In further embodiments, possibly, the layered structure can comprise just one middle layer. For this purpose, the channel 27 can be realized, for example, as a bore ending up in the first aperture 37. For this purpose, the first aperture 37 can comprise a blind hole within the single one middle layer of the coupling 1. Possibly, the coupling 1 can comprise just the first fluid conduit 5 coupled via the first aperture 37 to the channel 27 of the layered structure. For this purpose, the first aperture 37 is realized as a blind hole in the layered structure 3.

FIG. 5 shows a middle layer 65 of a coupling 67. The middle layer 65 comprises a first bore 69 and a second bore 71. The bores 69 and 71 are part of a pair of apertures of the coupling 67. Possibly, each aperture can receive a fluid conduit. The apertures or better the first and second bores 69 and 71 are connected via a channel 73 ending up in the first and second bores 69 and 71. The channel 73 can be realized, for example, as a slit or as a groove in the middle layer 65 of the coupling 67. Advantageously, an according layered structure of the coupling 67 can be realized by flexible materials, for example, elastic plastic materials. The layered structure of the coupling 67 can be build up same or similar as the described in FIG. 1 to 4. Advantageously, by the coupling 67, two fluid conduits can be coupled to each other. Furthermore, it is possible to couple a plurality of fluid conduits to each other. Due to the flexible materials, the coupling 67 realizes a bendable coupling of at least two fluid conduits, possibly each coupled to a light guide.

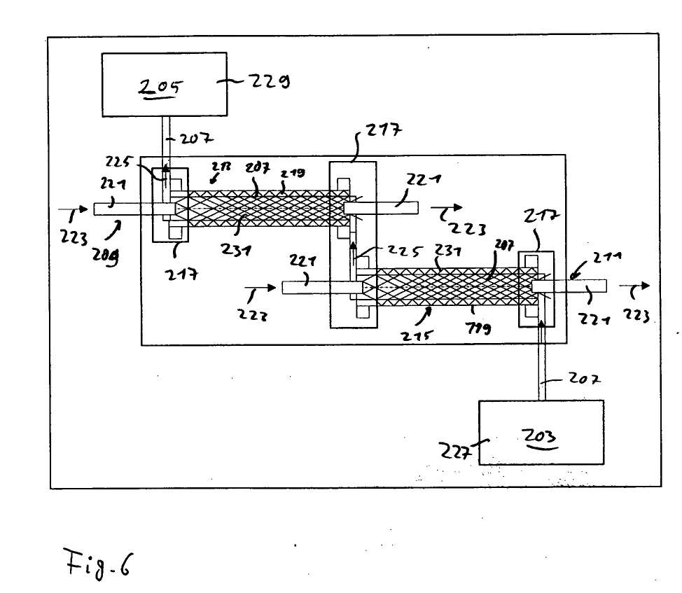

FIG. 6 shows a fluidic system 201 comprising a fluid source 203, for example a pump, a nanopump, and/or alike, and a fluid sink 205, for example a waste or a downstream coupled device, for example for analysis purposes.

Between the fluid source 203 and the fluid sink 205, the fluidic system 201 comprises a fluid path 207. The fluid path 207 is coupled with at least one light path 209. Possibly, the fluid path 207 of the fluidic system 201 can be coupled with a second light path 211. The fluid path 207 and the first and second light paths 209 and 211 belong to a first and a second flow cell 213 and 215.

For coupling the fluid path 207 and the first and second light paths 209 and 211, the fluidic system 201 comprises at least one coupling 217. The coupling 217 can be realized according to one of the couplings according to the Figures above.

Each of the flow cells 213 and 215 comprises a capillary 219 and comprises a wave guide 221. The capillaries 219 of the first and second flow cells 213 and 215 are adapted for conducting a fluid, for example, a fluid comprising a sample, for example, a sample dissolved in a liquid. For analyzing the sample of the fluid, the fluid can be irradiated by the wave guides 221 of the light paths 209 of the first and second flow cells 213 and 215. For measuring the amount of light guided through the fluid sample, the light paths 209 can be connected to not shown light detectors. The wave guide 221 can also be an optical element like a window, glass rod, and/or alike.

Furthermore, the coupling/s 217 can comprise a plurality of communicating branches, for example, for coupling the capillaries 219, the wave guides 213, and/or according supplying or rather draining conduits to each other.

The direction of the light guided though the light paths 209 of the first and second flow cells 213 and 215 is indicated by arrows 223. The direction of the fluid guided though the fluid paths 207 of the first and second flow cells 213 and 215 is indicated by arrows 225. Besides this, different beams of the light paths 209 are indicated by lines 231.

The capillaries 219 of the first and second flow cells 213 and 215 can comprise a transparent material, for example glass, quartz glass, and/or alike, wherein within the walls of the capillaries total reflection can occur as shown by the beams as indicated by the lines 231 of FIG. 6.

The fluid source 203 can comprise a separating device 227 and/or can be coupled with such a device. Besides this, the fluid sink 205 can comprise an analyzing device 229, for example, a mass spectrograph. The fluidic system 201 can be realized as an integrated system for analysis purposes, for example as a integrated system commercially available, for example, a chromatographic system (LC), a high performance liquid chromatographic (HPLC) system, an HPLC arrangement comprising a chip and an mass spectrograph (MS), a high throughput LC/MS system, a purification system, a micro fraction collection/spotting system, a system adapted for identifying proteins, a system comprising a GPC/SEC column, a nanoflow LC system, and/or a multidimensional LC system adapted for separation of protein digests.

The fluidic system 201 can be adapted for analyzing liquid. More specifically, the fluidic system 201 can be adapted for executing at least one microfluidic process, for example an electrophoresis and/or a liquid chromatographic process, for example a high performance liquid chromatographic process (HPLC). Therefore, the fluidic system 201 can be coupled to a liquid delivery system, in particular to a pump, and/or to a power source. For analyzing liquid or rather one or more components within the liquid, the fluidic system 201 can comprise a detection area, such as an optical detection area and/or an electrical detection area being arranged close to a flow path within the fluidic system 201. Otherwise, the fluidic system 201 can be coupled to a laboratory apparatus, for example to a mass spectrometer, for analyzing the liquid. For executing an electrophoresis, the flow path can comprise a gel. Besides this, the fluidic system can be a component part of a laboratory arrangement.

It is to be understood, that this invention is not limited to the particular component parts of the devices described or to process steps of the methods described as such devices and methods may vary. It is also to be understood, that different features as described in different embodiments, for example illustrated with different Fig., may be combined to new embodiments. It is finally to be understood, that the terminology used herein is for the purposes of describing particular embodiments only and it is not intended to be limiting. It must be noted, that as used in the specification and the appended claims, the singular forms of “a”, “an”, and “the” include plural referents until the context clearly dictates otherwise. Thus, for example, the reference to “a coupling” or “a fluid path” may include two or more such functional elements.

What is claimed is:

1. A coupling comprising:
a first conduit adapted for conducting and comprising an end to be coupled,
a layered structure adapted for providing a channel and adapted for coupling said channel with said end of said first conduit, and
a first aperture in said layered structure, wherein the aperture is adapted for introducing said end of said at least one conduit.

2. The coupling according to claim 1, wherein said coupling comprises at least one component selected from the group consisting of:
said first conduit is adapted for conducting a fluid,
said first conduit comprises one or more ends to be coupled,
said layered structure is adapted for coupling said channel with one or more conduits,
a first sealing layer adapted for sealing said first conduit,
a second sealing layer adapted for sealing a second conduit,
a first cover layer adapted for covering said first sealing layer and protecting said first sealing layer,
a first cover layer adapted for covering said first sealing layer or protecting said first sealing layer,
a second cover layer adapted for covering and protecting said second sealing layer,
a second cover layer adapted for covering or protecting said second sealing layer,
a first middle layer comprising said channel,
a second middle layer laminated with said first middle layer,
a third middle layer laminated on the other side than said second middle layer with said first middle layer,
each of said first and second sealing layers is laminated with one of said middle layers, and
said first sealing layer is laminated with said first cover layer, and said second sealing layer is laminated with said second cover layer.

3. The coupling according to claim 2, wherein said coupling comprises at least one component selected from the group consisting of:
said layered structure comprises at least five layers in the following order: said first cover layer, said first sealing layer, at least one of said middle layers, said second sealing layer, said second cover layer; and
said layered structure comprises at least three layers in the following order: said first sealing layer, at least one of said middle layers, said second sealing layer.

4. The coupling according to claim 1, wherein said channel is adapted for channeling a fluid to said end of said at least one conduit.

5. The coupling according to claim 1, wherein said channel ends up in said first conduit.

6. The coupling according to claim 2, wherein said coupling comprises at least one selected from the group consisting of:
said channel ends up in said first conduit via a circular gap,
said second conduit comprises a light guide,
said light guide ends up in said end of said first conduit, and
said light guide ends up coaxially in said end of said first conduit,

7. The coupling according to claim 2, wherein said first aperture and a second aperture are adapted for introducing said ends of said first and second conduits into said first and second sealing layers.

8. The coupling according to claim 2, wherein said coupling comprises at least one selected from the group consisting of:
said first middle layer comprises a slit adapted for providing said channel,
said first middle layer is laminated on one side with said second middle layer and on the other side with said third middle layer,
said second and third middle layers and said slit confine said channel,
said first middle layer comprises a groove adapted for providing said channel, and
said second middle layer and said groove confine said channel.

9. The coupling according to claim 1, where said coupling comprises at least one selected from the group consisting of:
a plurality of said apertures,
at least one of said channels adapted for channeling said fluid between at least two apertures of said plurality of apertures, and
a plurality of said conduits each inserted into one of said apertures.

10. The coupling according to claim 1, wherein said layered structure comprises a sealing material adapted for sealing said first conduit and surrounding said end of said first conduit.

11. The coupling according to claim 2, wherein said sealing material comprises a plastic material that was heated to at least partly plastifying or partly melting; and that was thereafter solidified.

12. The coupling according to claim 11, wherein said plastic material is at least one material selected from the group consisting of: a thermoplastic material, polyetheretherketone, a fluoropolymer, duroplastic, and a liquid crystal polymer.

13. The coupling according to claim 2, wherein said coupling comprising at least one selected from the group consisting of:
said first and second sealing layers comprise a plastic material,
said plastic material was heated between two of said layers,
said plastic material was heated between one of said layers and a housing,
said plastic material was heated between one of said layers and a tool, and
said plastic material was pressed between two of said layers and a housing or tool.

14. The coupling according to claim 11, wherein said plastic material was heated after assembling said coupling and said first and second conduits.

15. A fluidic system adapted for handling a fluid, said system comprising:
a coupling comprising a first fluid conduit adapted for conducting a fluid and comprising an end to be coupled, a layered structure providing a channel and adapted for coupling said channel with said end of said first conduit, and a first aperture in said layered structure.

16. The fluidic system according to claim 15, wherein said system is adapted for analyzing a fluid, and wherein said system comprises a flow cell for housing a fluid sample and for exposing said fluid sample to radiation for analysis, said flow cell comprising:
a capillary adapted for conducting said fluid sample,
a light path comprising said capillary, a first and a second light guide each adapted for conducting said light into and out of said flow cell, and
a fluid path comprising said capillary,
said coupling is adapted for coupling said light path and said fluid path,
said coupling comprises said first aperture coupled to one end of said analysis capillary, a second aperture coupled to one of said light guides, and said channel coupled to said capillary and to a supplying conduit.

17. The fluidic system according to claim 15, wherein said system comprising at least one component selected from the group consisting of:
two of said couplings,
at least two of said flow cells,
at least two of said flow cells coupled by at least one of said couplings,
said couplings comprise each a plurality of communicating branches,
a supplying conduit adapted for conducting said fluid sample into said capillary, and
said flow cell comprises a housing for supporting, positioning, and surrounding said capillary and said couplings.

18. The fluidic system according to claim 15, further comprising:
a fluid delivery system,
a separation device for separating components of said fluid delivered by said fluid delivery system, and
the flow cell adapted for detecting said separated components within said fluid.

19. The fluidic system according to claim 15, wherein said system comprises least one selected from the group consisting of:
a chromatographic system (LC),
a high performance liquid chromatographic (HPLC) system,
an HPLC arrangement comprising a chip and an mass spectrograph (MS),
a high throughput LC/MS system,
a purification system,
micro fraction collection/spotting system,
a system adapted for identifying proteins,
a system comprising a GPC/SEC column,
a nanoflow LC system, and
a multidimensional LC system adapted for separation of protein digests.

20. A method of coupling at least one conduit with a channel by a coupling for bringing said at least one conduit and said channel in communication with each other, the coupling comprising: a first fluid conduit adapted for conducting a fluid and comprising an end to be coupled, a layered structure providing a channel and adapted for coupling said channel with said end of said first conduit, and a first aperture in said layered structure, said method comprising:
inserting said end of said first conduit at least partly into said first aperture,
heating a sealing material of said layered structure at least partly for at least one of: plastifying, melting, and
solidifying said sealing material for sealing and fixing said conduits within said layered structure respectively aperture.

21. The method according to claim 20, where said method further comprises at least one additional step selected from the group consisting of:
heating and solidifying said sealing material within a tool,
heating and solidifying said sealing material within a housing,
heating and solidifying said sealing material partly,
heating and solidifying said sealing material at least partly by at least one of: inducing a current, leading a hot fluid through said at least one conduit,
closing a gap between said conduit and said plastic material by heating said plastic material, and
inserting an outer surface of said first conduit into said first aperture and an outer surface of a second conduit at least partly into a second aperture.
